(19) United States
(12) Patent Application Publication
(10) Pub. No.: US 2003/0084749 A1
(43) Pub. Date: May 8, 2003

(54) Adjustable pedal assembly with pedal ratio compensation

(76) Inventors: Brian Norman Orr, Chesterfield, MI (US); Waldemar Wawpzyniec Gmurowski, Sterling Heights, MI (US)

Correspondence Address: PATRICK M. GRIFFIN, DELPHI TECHNOLOGIES, INC., P.O. Box 5052, Mail Code: 480-414-420, Troy, MI, 48007-5052, US

(21) Appl. No.: 10/011,464

(22) Filed: Nov. 5, 2001

(51) Int. Cl. G05G 1/14

(52) U.S. Cl. 74/560

(57) ABSTRACT

An adjustable pedal assembly including a support structure that connects to a vehicle. The support structure includes first and second slots and a pivot point for allowing movement of the support structure with respect to a vehicle. A pedal assembly is disposed adjacent the support structure and is coupled with the support structure via first and second pins. A push rod assembly is coupled with the pedal assembly by a connection point. An actuator is interconnected with the pedal assembly and the push rod assembly such that the pedal assembly and the push rod assembly simultaneously move, such that a uniform mechanical advantage is maintained.

### Field of the Invention

The subject invention relates to adjustable pedal assemblies for vehicles, and more particularly to adjustable pedal assemblies having a constant mechanical advantage throughout the travel of the adjustable pedal assembly.

### BACKGROUND OF THE INVENTION

A person skilled in the art of vehicle pedals knows that a pedal location may be adjusted to accommodate different types of drivers. For example, a driver may desire to move the brake, clutch and accelerator pedals closer if the driver is shorter in stature. Various mechanisms have been developed in the art for moving pedals fore and aft with respect to the vehicle and the driver.

For example, U.S. Pat. No. 5,964,125 discloses an adjustable pedal system that moves the pedals fore and aft in a horizontal linear fashion on a tubular shaft.

Another type of prior art adjustable pedal assembly is detailed in U.S. Pat. No. 5,855,143. This system provides an arrangement of pivoting linkages to adjust the pedal location.

As the pedal arm of an adjustable pedal assembly moves towards or away from a driver, the mechanical advantage of the pedal changes due to the lengthening or shortening of the pedal with respect to support structures. Changes in mechanical advantage in turn can have effects on the ergonomic design of moveable pedal assemblies. A driver would feel as if differing forces were required to operate the pedal assembly when the pedal assembly is in different adjusted positions.

There is therefore, a need in the art to provide an adjustable pedal assembly that maintains a constant mechanical advantage as the pedal is adjusted to various positions.

### SUMMARY OF THE INVENTION

An adjustable pedal assembly for a vehicle includes a support structure adapted to connect to a vehicle, with the support structure including first and second slots arranged in a spaced apart manner. The support structure also includes a pivot point for allowing movement of the support structure with respect to the vehicle. A pedal assembly is disposed adjacent the support structure, and is supported for sliding movement on the support structure by first and second pins extending through the first and second slots respectively. There is also included a connection point which is defined by an interconnection of a push rod assembly and the pedal assembly. An actuator is connected with the pedal assembly and the push rod assembly such that the pedal assembly and the connection point defined by the interconnection of the pedal assembly and the push rod assembly simultaneously move such that a uniform mechanical advantage is maintained.

This invention provides a straightforward and simple mechanism that allows for maintaining a constant mechanical advantage as an adjustable pedal is moved to various positions. Further, the invention allows for variable movement of the pedal assembly and the connection point, again in an effort to maintain a constant mechanical advantage.

### BRIEF DESCRIPTION OF THE DRAWINGS

FIG. 1 is a perspective view of a preferred embodiment detailing the adjustable pedal assembly of the present invention.

FIG. 2 is a side view of the adjustable pedal assembly detailing the relationship of the pedal and connection point for maintaining a constant mechanical advantage.

FIG. 3 is a sectional view detailing the connection point of the push rod assembly and pedal assembly.

FIG. 4 is a side view detailing the pedal assembly in a first position.

FIG. 5 is a side view detailing the pedal assembly in a second position.

FIG. 6 is a side view of a second alternative embodiment of the adjustable pedal assembly of the present invention.

FIG. 7 is a third alternative embodiment of the adjustable pedal assembly of the present invention.

### DETAILED DESCRIPTION OF THE PREFERRED EMBODIMENT

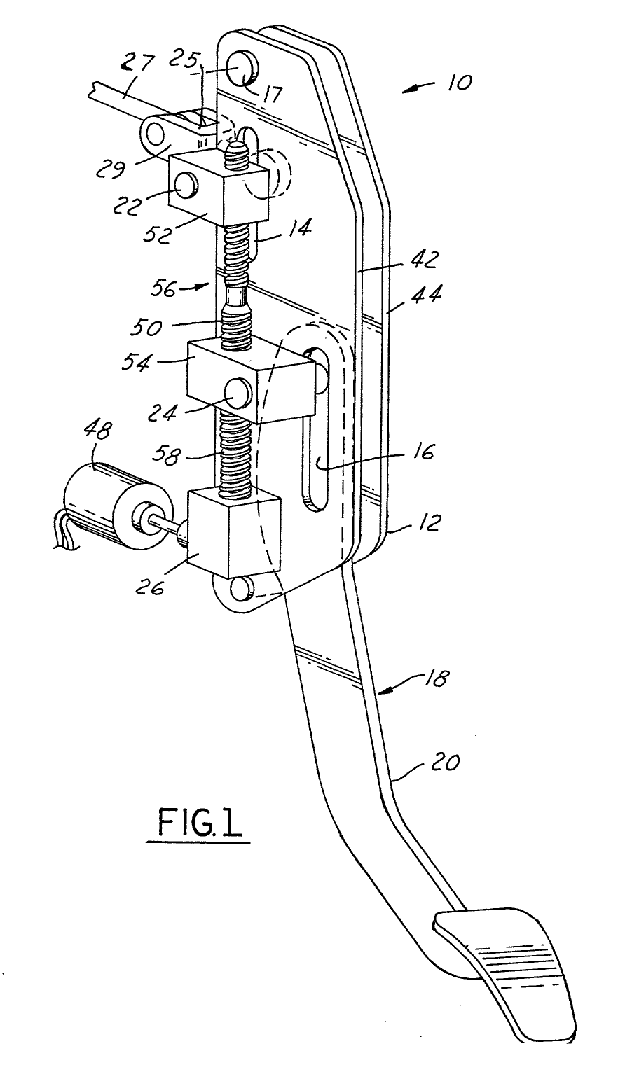

With reference to FIG. 1, there is shown a preferred embodiment of the adjustable pedal assembly 10.

In the picture preferred embodiment of FIG. 1, the adjustable pedal assembly 10 includes a support structure 12 adapted to connect to the vehicle (not shown), with the support structure 12 defining first and second slots 14, 16 arranged in a spaced apart manner. The support structure 12 also includes a pivot point 17 for allowing movement of the support structure 12 with respect to the vehicle.

A pedal assembly generally indicated at 18 is disposed adjacent the support structure 12, where the pedal assembly 18 includes a pedal 20. The pedal assembly 18 includes first and second pins 22, 24 extending through the first and second slots 14, 16 respectively, whereby the pedal assembly 18 is supported for sliding movement on the support structure 12.

A connection point 25 is defined by an interconnection of a push rod assembly 27 and the pedal assembly 18. An actuator 26 is connected with the pedal assembly 18 and the push rod assembly 27 to allow for movement of the pedal assembly along the support structure 12. The connection point 25 defined by the interconnection of the pedal assembly 18 and the push rod assembly 27 simultaneously moves with the pedal assembly 18 such that a uniform mechanical advantage is maintained.

Again with reference to FIG. 1, in a preferred construction, the support structure 12 has a first plate 42 defining the first and second slots 14,16 and a second plate 44 that is disposed parallel to the first plate 42. The second plate 44 defines third and fourth slots 46, 48 arranged parallel to the first and second slots 14,16, respectively. The first and second plates 42, 44 are connected in some suitable manner. The first and second plates 42, 44 may be connected by fastening devices such as double shouldered rivets, or may be interconnected by bending a single plate to form a U-shaped bracket.

The slots 14,16 are elongated straight slots, with the first slot 14 defining a first linear axis and the second slot 16 defining a second linear axis. The first slot 14 extends generally in a vertical direction, while the second slot 16 extends below the first slot and at an angle to the first slot whereby the first and second axes intersect. Various slot arrangements may be utilized to provide an ergonomic travel of the pedal assembly 18.

The support structure 12 may be fixed to the vehicle in a pivoting arrangement by a pivot point 17 which allows the support structure 12 to pivot with respect to the vehicle in response to operational forces applied to the pedal 20.

Again with reference to FIG. 1, a pedal assembly 18 including a pedal 20 is disposed adjacent the support structure 12. The pedal assembly 18 includes first and second pins 22, 24 extending through the first and second slots 14, 16 respectively, such that the pedal assembly 18 is supported for sliding movement on the support structure 12.

With reference to FIGS. 1 and 3, there is shown a connection point 25 defined by an interconnection of a push rod assembly 27 and the pedal assembly 18. In a preferred embodiment, the interconnection is achieved by a slide member 29 that is connected to the push rod assembly 27 and further coupled to the pedal assembly 18. As best seen in FIG. 3, the slide member 29 is connected to the push rod assembly 27 by a suitable fastening means such as a pin or rivet. The slide member is positioned between the first plate 42 and the second plate 44 and connected with the pedal assembly 18 by the first pin 22 which extends through the first slot 14. In this manner, the connection point 25 varies its position as the adjustable pedal assembly 10 is adjusted to various positions.

Various actuators may be used to move the pedal assembly 18 along its adjustable travel path relative to the support structure 12. In the preferred embodiment shown in FIG. 1, the actuator 26 is a jackscrew type actuator which includes a drive mechanism 48 connected to a jackscrew 50. The jackscrew 50 is preferably positioned on a side 56 of the support structure 12. First and second nuts 52, 54 are threadably engaged with the jackscrew 50 to facilitate movement of the push rod assembly 27 and pedal assembly 18. As can be seen in FIG. 1, the first nut 52 is operatively connected with the first pin 22 and the second nut 54 is operatively connected with the second pin 24. The pins 22, 24 extend through their respective slots to provide the pedal assembly 18 and push rod assembly 27 support for sliding movement on the support structure 12.

Again with reference to FIG. 1, the jackscrew 50 may have differing thread pitches associated with the first nut 52 and the second nut 54. This arrangement allows for differential movement of the push rod assembly 27 and pedal assembly 18 such that a constant mechanical advantage may be maintained. The drive mechanism 48 is connected with the actuator 26 at a bottom 58 of the jackscrew 50 to facilitate Movement of the jackscrew 50.

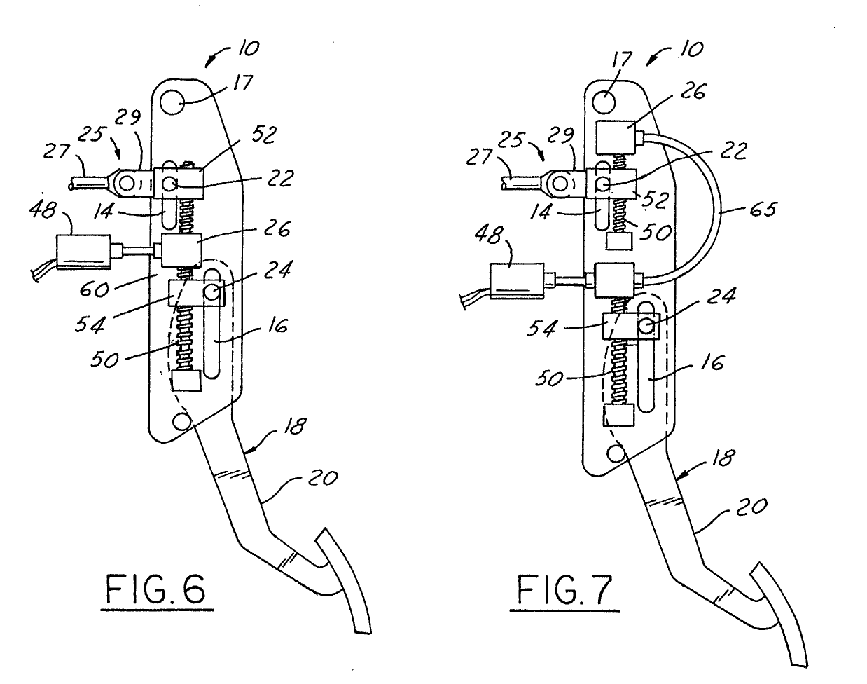

With reference to FIG. 6, there is shown a second alternative embodiment of the adjustable pedal assembly 10 of the present invention. The depicted alternative embodiment is similar to that of the preferred embodiment except that the actuator 26 and the drive mechanism 48 are positioned in a middle 60 of the jackscrew 50.

With reference to FIG. 7 there is shown a third alternative embodiment which is similar to the preferred embodiment with the exception that there are two actuators 26 and 49 associated with two jack screws 50. A single drive mechanism 48 provides the rotational force to drive both the first and second actuators 26, 49 respectively. The first and second actuators 26, 49 are connected by a flex-cable 65 that provides a uniform rotation of both the jack screws 50. As with the preferred embodiment, the jackscrews 50 may have different pitches to provide differential movement of the push rod assembly 27 and the pedal assembly 18.

In operation of any of the embodiments, a person may adjust the location of the pedal 20 via a remote switch that triggers the actuator 26. The actuator 26, through an appropriate gear system (not shown) in turn drives the jackscrew 50. The movement of the jack screw 50 in turn moves the first nut 52 and second nut 54 to facilitate movement of the push rod assembly 27 and pedal assembly 18, respectively. Movement of the first nut 52 in turn moves the first pin 22 in the first slot 14 which is coupled with the slide member 29; thereby facilitating movement of the push rod assembly 27. Movement of the second nut 54 in turn moves the second pin 24 with in the second slot 16 thereby moving the pedal assembly 18 to various positions.

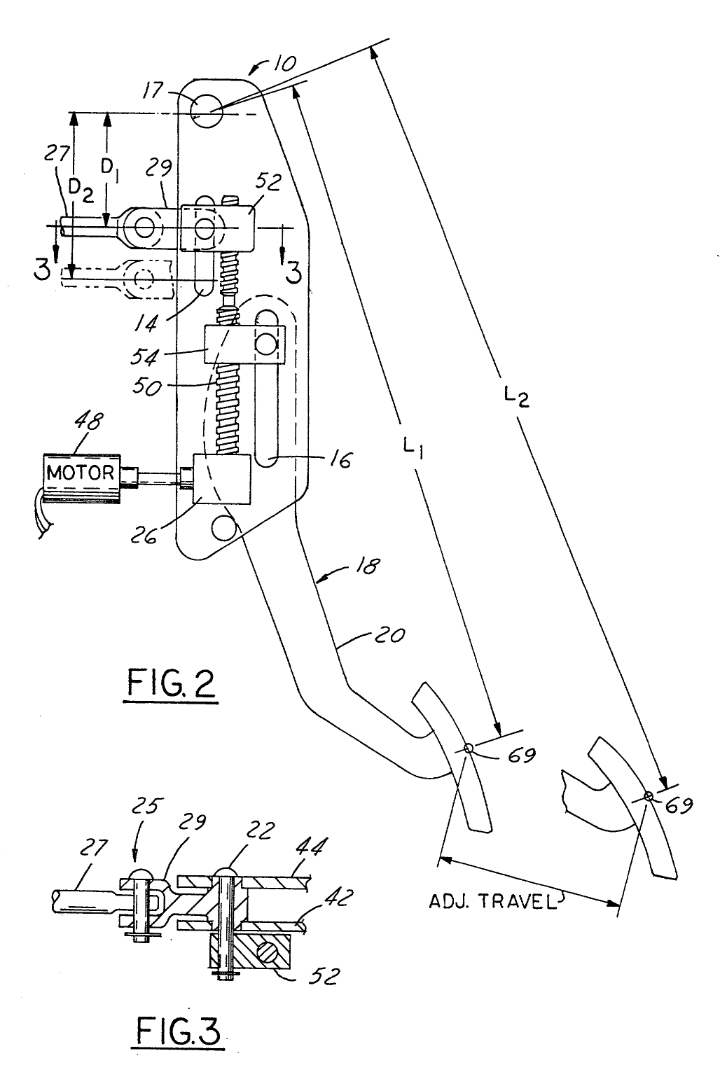

With reference to FIG. 2, there is shown the adjustable pedal assembly 10 in two positions denoted by distances L1 and L2 which correspond to a length from the pivot point 17 to a center of the pedal pad 69 in a first position and a distance L2 corresponding to a length from the pivot point 17 to the center of the pedal pad 69 in a second position. Also denoted in FIG. 2, are distances D1 and D2 which correspond to lengths from the pivot point 17 to a center line of the push rod assembly 27 in a first position (D1) and a second position (D2). The ratio of the lengths L1 over D1 is equal to the ratio of the lengths L2 over D2. In this manner, a constant mechanical advantage may be maintained as the pedal is adjusted from the first position to a second position.

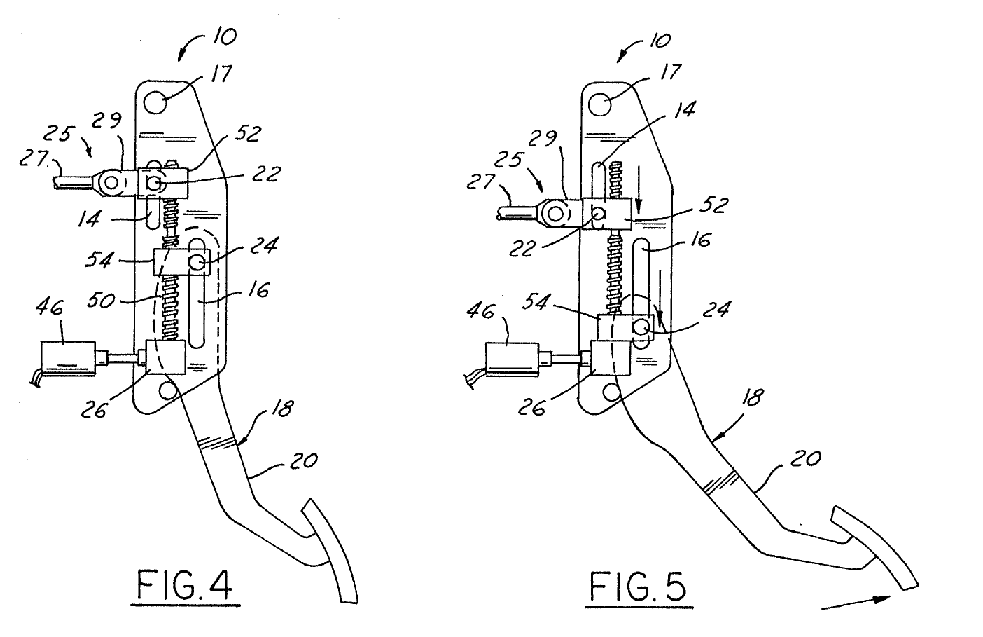

With reference to FIGS. 4 and 5, there is denoted the adjustable pedal assembly 10 in a first position in FIG. 4, and the adjustable pedal assembly 10 in a second position in FIG. 5. As can be seen by a comparison of FIGS. 4 an 5, as the pedal 20 moves towards a driver, the push rod assembly 27 moves away form the pivot point 17 such that the mechanical advantage of the pedal assembly is maintained. Alternatively, as the pedal assembly 10 is adjusted away from a driver, the push rod assembly 27 moves towards the pivot point 17, again such that a mechanical advantage is maintained.

While preferred embodiments are disclosed, a worker in this art would understand that various modifications would come within the scope of the invention. Thus, the following claims should be studied to determine the true scope and content of this invention.

I claim:

1. An adjustable pedal assembly comprising:
a) a support structure adapted to connect to a vehicle, the support structure including first and second slots arranged in a spaced apart manner, and wherein the support structure includes a pivot point for allowing movement of the support structure with respect to the vehicle;
b) a pedal assembly including a pedal disposed adjacent the support structure, the pedal assembly including first and second pins extending through the first and second slots, respectively, whereby the pedal assembly is supported for sliding movement on the support structure;
c) a connection point defined by an interconnection of a push rod assembly and the pedal assembly;
d) an actuator interconnected with the pedal assembly and the push rod assembly for moving the pedal assembly to a desired position along the support structure; and
wherein the connection point defined by the interconnection of the pedal assembly and the pushrod assembly simultaneously moves with the pedal assembly such that a uniform mechanical advantage is maintained.

2. The adjustable pedal assembly of claim 1 wherein the interconnection comprises a slide member connected to the push rod assembly and further coupled to the pedal assembly by either of the first or second pins extending through the first and second slots, respectively.

3. The adjustable pedal assembly of claim 2 wherein the slide member is coupled to the pedal assembly by the first pin.

4. The adjustable pedal assembly of claim 2 wherein the slide member is coupled to the pedal assembly by the second pin.

5. The adjustable pedal assembly of claim 2 wherein the support structure has a first plate defining the first and second slots, and a second plate disposed parallel to the first plate, the second plate defining third and fourth slots arranged parallel to the first and second slots, respectively.

6. The adjustable pedal assembly of claim 5 wherein the slide member is positioned between the first and second plates and coupled to the pedal assembly by the first pin extending through the first slot, slide member and third slot.

7. The adjustable pedal assembly of claim 1 wherein the actuator comprises a jack screw type actuator including a drive mechanism connected to a jack screw having first and second nuts threadably engaged therewith, and wherein the first nut is operatively connected with the first pin and the second nut is operatively connected with the second pin to facilitate movement of the push rod and pedal assembly.

8. The adjustable pedal assembly of claim 7 wherein the jack screw has a differing thread pitch with respect to where the first and second nuts engage the jackscrew to facilitate differential movement of the push rod and pedal assembly.

9. The adjustable pedal assembly of claim 8 wherein the jackscrew is positioned on a side of the adjustable pedal assembly and wherein the drive mechanism is positioned at a bottom of the jackscrew.

10. The adjustable pedal assembly of claim 8 wherein drive mechanism is positioned in a middle of the jackscrew.

11. The adjustable pedal assembly of claim 1 further including a second actuator.

12. The adjustable pedal assembly of claim 11 wherein the first and second actuators comprises a jack screw type actuator including a drive mechanism connected to a jackscrew and wherein the first actuator has a first nut threadably engaged therewith, and wherein the first nut is operatively connected with the first pin and the second actuator has a second nut threadably engaged therewith and wherein the second nut is operatively connected with the second pin to facilitate movement of the push rod and pedal assembly.

13. The adjustable pedal assembly of claim 12 wherein the thread pitch of the first actuator differs from that of the second actuator to facilitate differential movement of the push rod and pedal assembly.

14. The adjustable pedal assembly of claim 12 wherein a single drive mechanism operates both the first and second actuators.

15. The adjustable pedal assembly of claim 1 wherein the connection point moves away from the pivot point as the pedal assembly moves away from a driver.

16. The adjustable pedal assembly of claim 1 wherein the connection point moves towards the pivot point as the pedal assembly moves towards a driver.

17. An adjustable pedal assembly comprising:
a) a support structure adapted to connect to a vehicle, the support structure including first and second slots arranged in a spaced apart manner, and wherein the support structure includes a pivot point for allowing movement of the support structure with respect to the vehicle;
b) a pedal assembly including a pedal disposed adjacent the support structure, the pedal assembly including first and second pins extending through the first and second slots, respectively, whereby the pedal assembly is supported for sliding movement on the support structure;
c) a connection point defined by an interconnection of a push rod assembly and the pedal assembly wherein the interconnection comprises a slide member connected to the push rod assembly and further coupled to the pedal assembly by either of the first or second pins extending through the first and second slots, respectively;
d) an actuator interconnected with the pedal assembly and the push rod assembly for moving the pedal assembly to a desired position along the support structure; and
wherein the connection point defined by the interconnection of the pedal assembly and the pushrod assembly simultaneously moves with the pedal assembly such that a uniform mechanical advantage is maintained.

18. An adjustable pedal assembly comprising:
a) a support structure adapted to connect to a vehicle, the support structure including first and second slots arranged in a spaced apart manner, and wherein the support structure includes a pivot point for allowing movement of the support structure with respect to the vehicle;
b) a pedal assembly including a pedal disposed adjacent the support structure, the pedal assembly including first and second pins extending through the first and second slots, respectively, whereby the pedal assembly is supported for sliding movement on the support structure;
c) a connection point defined by an interconnection of a push rod assembly and the pedal assembly;
d) an actuator interconnected with the pedal assembly and the push rod assembly for moving the pedal assembly to a desired position along the support structure, wherein the actuator comprises a jack screw type actuator including a drive mechanism connected to a jack screw having first and second nuts threadably engaged therewith, and wherein the first nut is operatively connected with the first pin and the second nut is operatively connected with the second pin to facilitate movement of the push rod and pedal assembly; and
wherein the connection point defined by the interconnection of the pedal assembly and the pushrod assembly simultaneously moves with the pedal assembly such that a uniform mechanical advantage is maintained.
